(19) United States
(12) Patent Application Publication
(10) Pub. No.: US 2002/0082927 A1
(43) Pub. Date: Jun. 27, 2002

(54) Intelligent caching routers

(76) Inventors: Nathaniel S. Borenstein, Ann Arbor, MI (US); Kurt Brown, Ann Arbor, MI (US); Keith Harder, Ann Arbor, MI (US); John Christopher Kaltwasser, Ann Arbor, MI (US); Greg Merriman, Ann Arbor, MI (US); Daniel Pritts, Ann Arbor, MI (US)

Correspondence Address: John G. Posa, Gifford, Krass, Groh et al, Suite 400, 280 N. Old Woodward Ave., Birmingham, MI, 48009, US

(21) Appl. No.: 09/989,942

(22) Filed: Nov. 21, 2001

Related U.S. Application Data
(60) Provisional application No. 60/252,848, filed on Nov. 22, 2000.

(51) Int. Cl. G06F 17/60; G06G 1/12; G06F 15/16

(52) U.S. Cl. 705/21; 705/16; 709/227; 709/203

(57) ABSTRACT

An intelligent caching router (ICR) balances the cost-saving and functionality-enhancing benefits of the application-service-provider (ASP) model of software delivery against the inherent risks of relying on networked computing. In so doing, the ICR makes the ASP model practical for services that require extremely high levels of reliability and availability. The ICR is inserted functionally between a (thin) client and the network (i.e., Internet, intranet or extranet) and performs certain operations, including the logging of “mission-critical” application state data; network connectivity monitoring; traditional backup routing features; mission-critical server emulation; and server resynchronization upon reconnection. When networking problems are detected, the ICR initially takes steps to try and restore connectivity. In taking such actions, the ICR is largely behaving as a traditional intelligent network router. However, when such traditional backup routing fails, the ICR begins to act as a surrogate for the unreachable remote server on which the application service depends. In particular, for the application subset that the service providers have deemed “mission critical,” the ICR makes application-specific responses to permit operations to continue, and logging the requests and response it has issued. When the communications link is restored, the ICR will re-synchronize with the remote server and then return to its normal “passive” operation. The invention is particularly suited to electronic commerce transactions, since accounting, crediting or debiting may be considered critical transactions, whereas other forms of updating, reporting, and the like are typically less critical. One disclosed example shows the role of an ICR in a point-of-sale application.

### REFERENCE TO RELATED APPLICATION

This application claims priority from U.S. provisional application Serial No. 60/252,848, filed Nov. 22, 2000, the entire contents of which is incorporated herein.

### FIELD OF THE INVENTION

The present invention relates generally to the maimer in which users at a physical site are given access to information services delivered over a network and, more particularly, to benefits associated with combining centralized services and administration while maintaining the high-reliabilty of locally-based services.

### BACKGROUND OF THE INVENTION

The history of computing services shows a persistent and long-term tension between the advantages of localized and distributed computing. The introduction of time-sharing systems in the 1960's ushered in an era of shared access to centralized resources, in which relatively inexpensive terminal devices shared access to expensive centralized computing services. This model permitted enormous cost efficiencies and made computing power much more widely available.

The introduction of personal computers in the 1970's and 1980's demonstrated the benefits of the inverse approach: localized processing power was important for providing sophisticated user interfaces to increasingly complex applications, and was widely perceived as empowering users by reducing their dependence on a centralized computing enterprise and bureaucracy.

Both models persist because neither is clearly superior in all respects. Distributed computing is well known to create administrative and support nightmares, while centralized computing is well known to frustrate end users attempting to make creative new uses of computing resources, and to suffer dramatic, paralyzing losses of service in the event of network problems.

The advent of the World Wide Web has preserved this dichotomy while moving it onto a new environment, where standardized network protocols greatly increase the potential effective domain of any computing application. Accordingly, client/server applications using these protocols typically come in two models, locally-based and Application Service Provider (ASP). In a locally-based web application, the web server exists on-site, and Internet protocols are simply used as any other local network protocols might be used. In the ASP (Application Service Providers) model, the application server exists completely off-site, and is centrally administered and operated. Clearly a locally-based service is more reliable because it does not depend on wide-area networking, while an ASP-based service is far less work to operate and maintain at the local site.

Prior art in this area has focused almost entirely on unidirectional communication. One widely used technique is “web proxy caching,” in which a locally sited server maintains a cache of information from a plurality of remote servers. When combined with mechanisms to ensure the cache's completeness, this mechanism can improve the reliability of a web-based application by providing disconnected access to all static data from the remote server. However, the unidirectional nature of a proxy cache does not meet the needs of transaction-based systems in which locally-originated transaction data needs to be processed and stored on a central server.

Another established technique is a “web mirror,” in which an entire web site is maintained as a secondary copy of another, with relatively infrequent updates to preserve consistency. A web mirror has the advantage of always providing a complete copy of a remote database, but at the cost of being unable to guarantee its consistency with the central database, since updates are not automatically propogated. Moreover, like a proxy cache, a web mirror has no mechanism for ensuring the consistency of locally-originated transactions with the central database.

Earlier in the history of computing, similar problems were addressed through the use of “staging servers.” A staging server is a computer server developed for the express purpose of performing intermediate local processing before application-level synchronization with a central server. Staging servers remain common in batch-oriented legacy applications, where they generally serve the purpose of consolidating and aggregating local transactions until the time arrives for such data to be uploaded to a central service. However, they are based on the expectation that such uploads are infrequent and that connectivity to the central service is sporadic and generally unavailable, which implies that a staging server must be treated as a full server in its own right for purposes of backup, administration, and system maintenance.

Fundamentally, however, existing systems require a major trade-off between the simplification and cost savings of an ASP-like model and the highest possible levels of application reliability and availability. This tradeoff made the ASP model unsuitable for any “mission-critical” software applications.

### SUMMARY OF THE INVENTION

This invention improves upon the existing art by providing an intelligent caching router that is inserted functionally into the traditional ASP model, between the thin client and the network (i.e., Internet, intranet or extranet). Broadly, the ICR augments the existing routing technology to balance the cost-saving and functionality-enhancing benefits of the ASP model of software delivery against the inherent risks of relying on networked computing. In so doing, the ICR makes the ASP model practical for services that require extremely high levels of reliability and availability.

Generally speaking, each ICR implementation performs certain operations, including the logging of “mission-critical” application state data; network connectivity monitoring; traditional backup routing features; mission-critical server emulation; and server resynchronization upon reconnection. When networking problems are detected, the ICR initially takes steps to try and restore connectivity. In taking such actions, the ICR is largely behaving as a traditional intelligent network router. However, when such traditional backup routing fails, the ICR begins to act as a surrogate for the unreachable remote server on which the application service depends.

In particular, for the application subset that the service providers have deemed “mission critical,” the ICR makes application-specific responses to permit operations to continue, and logging the requests and response it has issued. When the communications link is restored, the ICR will re-synchronize with the remote server and then return to its normal “passive” operation.

The invention is particularly suited to electronic commerce transactions, since accounting, crediting or debiting may be considered critical transactions, whereas other forms of updating, reporting, and the like are typically less critical. One disclosed example (of many), shows the role of an ICR in a point-of-sale application.

### BRIEF DESCRIPTION OF THE DRAWINGS

FIG. 1 is an outline of the initialization logic to be executed by an Intelligent Caching router (ICR) at startup;

FIGS. 2 through 6 outline the logic of each of five process threads launched by the ICR at startup, wherein, in particular:

FIG. 2 illustrates that when a transaction is received from the thin client, the ICR spawns a new thread, subroutine, procedure, or other process for responding to the request;

FIG. 3 shows how the Internet Connection Control Process wakes up periodically and checks the globally-available settings describing the current state of the Internet connection;

FIG. 4 shows how the Transaction Synchronization Process wakes up periodically and checks to see if there are any transactions are in the synchronization queue and if the Internet connection is functional;

FIG. 5 shows how the Data Cache Control Process waits for the remote server to notify it of data that needs to be updated, and then downloads that data from the remote server;

FIG. 6 shows how the Program Cache Control Process periodically polls the remote server to request a list of programs that needs to be updated, and then downloads those programs from the remote server; and

FIG. 7 shows the role played by an ICR in the context of a larger application such as an Internet-based retail point-of-sale system.

### DETAILED DESCRIPTION OF THE INVENTION

Before describing the invention in detail, the following terms will be introduced with respect to their roles in the new method:

### DEFINITION OF TERMS

A “SOFTWARE APPLICATION” is any application of computing technology to provide a specific type of functionality to human users. It is distinguished from software that does not have, as its main purpose, direct satisfaction of a user-level request. Thus, for example, electronic mail, spreadsheets, and web browsing are considered software applications, while file systems, display drivers, and device or network management code are not.

A “REMOTE SERVER” is a computing engine that is located at a significant physical distance from the human user, substantially outside of the user's direct control. An “APPLICATION SERVICE PROVIDER (ASP)” is an entity that delivers software applications wide area delivery networks such as the Internet and its constituent networks, or similar networks. In the ASP model, most of the “intelligence”, or software logic, takes place on a remote server, while the user's local machine (herein called the “THIN CLIENT”) serves primarily to manage the human-computer interface (input and output).

An “INTELLIGENT CACHING ROUTER (ICR)” is a software or hardware object that interposes itself between the thin client and the remote server. It is itself a highly-specialized hybrid application, neither a pure client nor server, the only purpose of which is to increase the overall reliability of software applications delivered by ASP's over a sporadically unreliable remote connection.

“MISSION-CRITICAL” functionality is the subset of functionality, in a software application, that has the highest possible requirements for reliability and availability. The division of a software application into mission-critical and non-mission-critical subsets is highly application dependent, but has traditionally rarely been formalized.

### ICR System Description

An ICR is a component that is inserted into the traditional ASP model, in between the thin client and the Internet (or Intranet/extranet):

THIN CLIENT←→ICR←→INTERNET←→REMOTE SERVER

Because it is co-located on the client end (possibly even as a software application running on the same hardware as the application), the link between the client and the ICR is fundamentally immune to communication difficulties inherent in the use of the Internet. In normal operation, an ICR functions as a passive observer of the traffic between the client and the server, logging only enough state to permit it to perform its primary function, the preservation of mission-critical functionality in the event of network connectivity problems, and monitoring the ongoing network traffic in order to quickly detect such problems when they occur.

When networking problems are detected, the ICR becomes more active. Initially, it will take steps to try to restore connectivity. Such steps may include, but are not limited to: Routing traffic to an alternative network provider; establishing communication via a backup link such as a dial-up line; or using paging or other independent communication technology to notify network administrators of an outage. In taking these actions, the ICR is largely behaving as a traditional intelligent network router. It is what the ICR does when traditional backup routing fails that differentiates an ICR from traditional routers. In such cases, an ICR begins to act as a surrogate for the unreachable remote server on which the application service depends.

For the application subset that the service providers have deemed “mission critical,” the ICR makes application-specific responses to permit operations to continue, and logging the requests and response it has issued. When the communications link is restored, the ICR will re-synchronize with the remote server and then return to its normal “passive” operation.

The ICR augments hardware and software routing technology to include minimal emulation of application servers during transient communication outages. It provides a new way of balancing the cost-saving and functionality-enhancing benefits of the ASP model of software delivery against the inherent risks of relying on Internet-like wide area networking technology, and thus makes the ASP model practical for services that require extremely high levels of reliability and availability.

For example, one strong benefit of ASP-delivered software services is the elimination of the need for data backup at each remote site. In an ASP, the local machines—the thin clients—are interchangeable, so that a ruined disk may be easily replaced without concern for the data it contains. In a fully local service, on the other hand, local data backup is essential. The use of ICR actually involves only one potential point of data loss: if the hardware on which the ICR resides fails catastrophically during a period of network outages, some data will indeed be lost. However, even though this creates a small window for data loss in ASP services, such risk is in fact much smaller than the risk, in traditional software services, of the loss of all data newer than the last backup. Thus this risk is likely to be perceived as a very acceptable cost for the reduction of the risk of catastrophic connectivity loss. The risk can itself be further minimized by the ASP designer's choice of which data to consider so mission-critical as to make it locally-processed and hence subject to this kind of risk.

The introduction of an ICR into the ASP model for delivering information services also requires additional sophistication at the level of Internet connection management. Within the local site, the thin client machines will typically, in the preferred embodiment, be configured to address only the machines on the local network, one of which is the ICR. This configuration insulates the thin client machines from any dependence on the external network, but imposes on the ICR the necessity of managing the IP address space. An ICR will therefore often include the traditional functionality of a NAT (Network Address Translation) router. In general, the ICR is a logical place to include any routing or firewall functionality desired for the application, because it sits in the right spot architecturally as the only local machine that actually communicates to the Internet. It will also generally makes sense for the ICR to perform DNS (domain name system) lookup, DHCP (dynamic host configuration protocol) service, and any other network services that are essential for the functioning of the local thin client machines.

### Basic Features

To implement an ICR for a particular software application, it is first necessary to determine which aspects of the application are to be considered mission-critical. This is essentially an additional design stage, in which the designer of the application service is empowered with relatively fine-grain control over the traditional tradeoff between simplicity and cost-effectiveness of local operations and the reliability and availability of the overall system service.

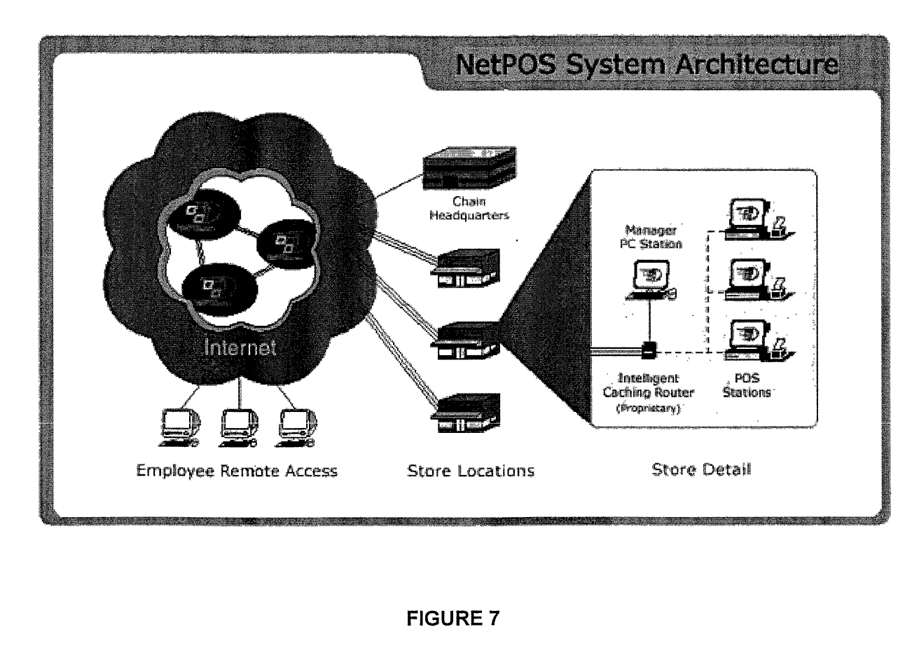

The invention is particularly suited to electronic commerce transactions, since accounting, crediting or debiting may be considered critical transactions, whereas other forms of updating, reporting, and the like are typically less critical. As one example, FIG. 7 shows the role of an ICR in a point-of-sale application. Here, the ICR is used to permit sales transactions to continue to be processed in the event of Internet outages, while non-mission-critical functionality related to reporting, inventory data, or customer relationship management might be unavailable during the interruption.

According to the invention, each ICR implementation performs the following basic operations:

1. Logging of “mission-critical” application state data. Every time a local user on the thin client terminal performs an operation that changes the state of the application, this information may optionally be responded to immediately by the ICR (to avoid user-level delays due to network problems) and then must be established as a permanent state change, by both changing the cached data in the ICR and ensuring that the authoritative data at the remote server is similarly changed. The latter action will be nearly immediate in the general case, but could be significantly delayed in the event of network problems. When such problems occur, the ICR is responsible for queuing up all such changes until connectivity is restored.

2. Network monitoring and detection of outages. The ICR must pro-actively monitor network connectivity, to ensure that network problems are detected in a “background” mode rather than while a user is waiting for a mission-critical response.

3. Traditional backup routing features. The ICR is responsible for choosing among a plurality of available mechanisms and routes by which to connect to the Internet, to establish backup connectivity whenever the primary or currently-used connectivity mechanism fails.

4. Mission-critical server emulation. The ICR is able to act in place of the remote server during transient Internet outages, which means that it must maintain a cached copy of all mission-critical server data as well as a cached copy of the actual server processing code.

5. Server resynchronization upon reconnection. After an Internet outage, the ICR must be able to resynchronize its state with the remote server, ensuring that all mission-critical processing that took place during the outage is properly reflected in the remote server's state information (typically its database).

### System Security

In general, an ASP using an ICR has roughly the same security profile as any other ASP. For example, data must be encrypted for transport over the Internet if it is to be protected from the view of third parties, and the local client must authenticate itself to the remote server; if the authentication mechanism is compromised, third parties can masquerade as the local client. For the most part, these security issues are unchanged by the introduction of an ICR, and can be dealt with using established techniques, including (but not limited to) hardware encryption, software encryption, formal procedures for id and password management, third party security audits, tiger teams, and user education.

The introduction of an ICR adds one additional security consideration, which is the risk of having mission-critical data that exists only in a relatively transient local data store. In this regard, because the ICR hybridizes the ASP model to introduce a transient local store, it also hybridizes the security threat profile to include the local storage issues from which a pure ASP is somewhat exempt. Threats to local data security should be addressed in the manner traditional for site-based (i.e. non-ASP) applications: physical security, access controls, and usage monitoring are the key protection mechanisms available.

The logic and actions that constitute an ICR may be carried out on any number of possible computing platforms, such as a commercial or non-commercial operating system, a programmable logic unit in which all operations are embedded in “firmware”, or any other engine capable of supporting the ICR logic Such an engine will require an (application-dependent) adequate amount of temporary storage area for the cached data, which may be provided via magnetic disk, non-volatile (“flash”) memory, or any other rewritable storage medium.

### Description of ICR Startup Process

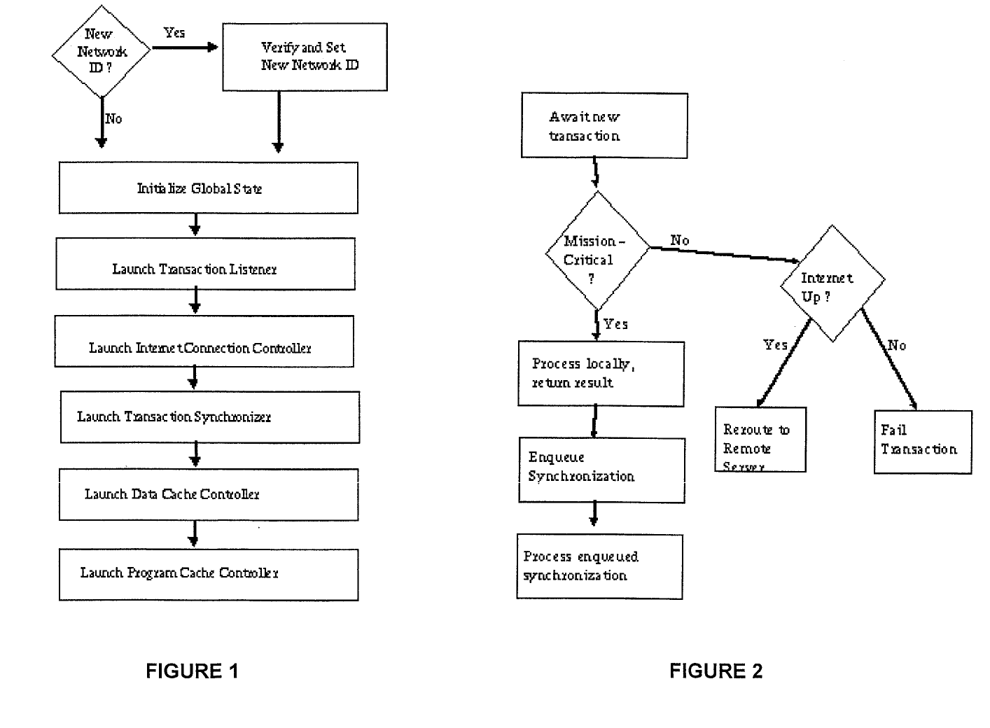

Referring to FIG. 1, when an ICR is turned on or restarted, it may first seek to ascertain whether or not it is being assigned a new network identity. This may be implemented using a variety of methods, such as:

physical switches built in to an ICR implemented as a dedicated hardware system,

initialization files used by an ICR implemented on top of a standard computer operating system,

physical cues such as keyboard commands issued at power-on via hardware connected to the ICR.

If a new network identity is being assigned, the ICR ascertains and verifies its new identity before proceeding. (In an alternate embodiment, it might also be possible to change the network identity in the middle of operation.) The network identity is used by the ICR to locate the remote server whose service it is augmenting, and optionally to identify and authenticate the ICR to that remote server.

After optionally verifying a new network identity, the ICR initializes its global state variables and launches one or more processes whose collective operation implements the functionality of the ICR. These are described here as separate computing processes, or threads, for simplicity of understanding, but an alternate embodiment could combine all of these processes into a single or smaller number of threads. The ICR initializes a global variable describing the current Internet connectivity state (typically initialized to “no connection”) and launches the five processes that are shown in FIGS. 2-6.

### Transaction Listener Process

The ICR Transaction Listener Process waits until the ICR receives a transaction request from one of the Thin Client terminals, much like a web server or any other network server. A transaction request may come in the form of an HTTP (web) transaction or may use any other transaction-oriented network protocol.

As shown in FIG. 2, when a transaction is received from the thin client, the ICR spawns a new thread, subroutine, procedure, or other process for responding to the request. It first evaluates the request to see if it is in the application subset designated as “mission-critical.” If the transaction is not mission-critical, then the transaction is simply re-routed to the remote server if the Internet connection is functioning, or returns a failure code to the Thin Client terminal if the Internet is unavailable or the server is otherwise unreachable.

Several variations of this sequence are possible, including performing immediate processing of the synchronization transaction, or delaying the provision of a mission-critical result to the Thin Client until the server's answer is received in the case where the Internet is currently available.

### Internet Connection Control Process

The ICR Internet Connection Control Process continuously monitors the state of the ICR's connection to the Internet, providing state information to the other processes that allows them to base their logic on the known state of the Internet without necessarily having to re-test connectivity before each operation. (In an alternate, less efficient embodiment, such testing might be done implicitly or explicitly for every network-related operation, in which case the Internet Connection Control Process would not be needed.)

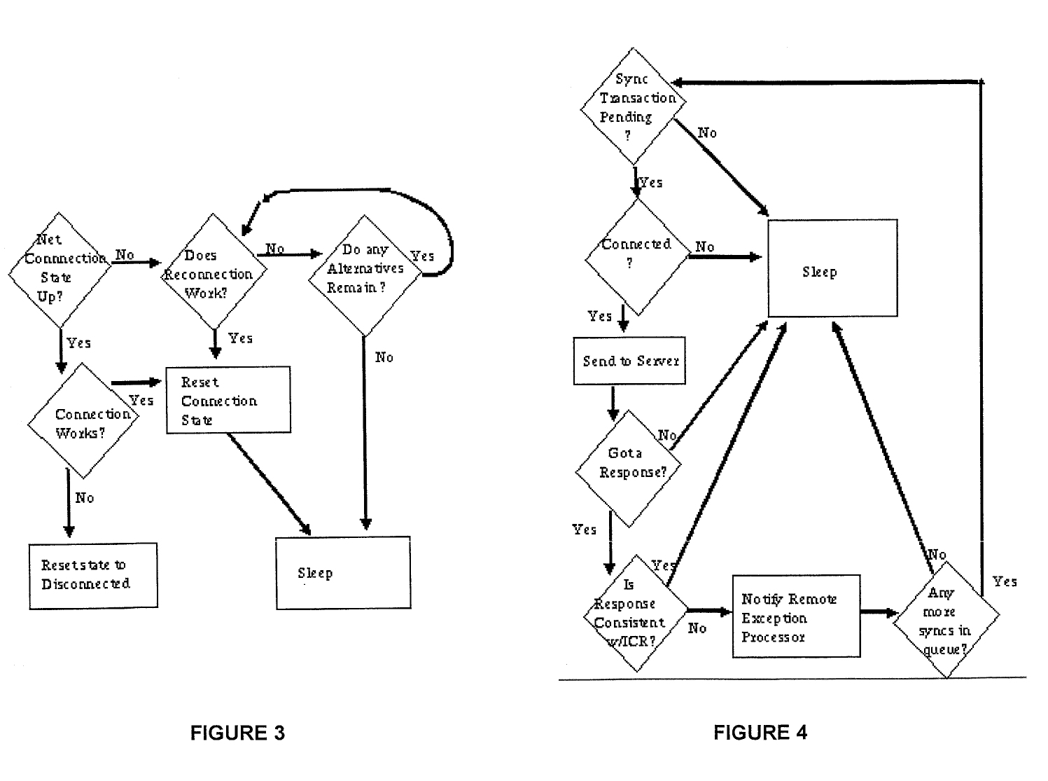

As shown in FIG. 3, the Internet Connection Control Process wakes up periodically and checks the globally-available settings describing the current state of the Internet connection. If the Internet connection is currently believed to be functional, this process seeks to confirm that connectivity by communicating briefly with the remote server. If that communication fails, the global state is altered to indicate that no Internet connectivity is currently available.

If no connection is available, the ICR attempts to reconnect to the Internet via a plurality of configured mechanisms, which may include dedicated connections such as leased lines, DSL, cable modems, satellite connections, modems on conventional telephone lines, or wireless modems. If connectivity is restored via any of these mechanisms, the global state is updated accordingly. In any event, the Internet Connection Control Process waits for a certain amount of time and then repeats the entire process again.

### Transaction Synchronization Process

The ICR Transaction Synchronization Process is responsible for making sure that all mission-critical transactions that have been processed by the ICR are synchronized, as quickly as practical, with the remote server. In normal, connected operation, this process seeks to empty its queue (and thus fully synchronize transaction state with the remote server) within a very brief interval after the transaction synchronization request is generated. However, the transaction queue will retain unprocessed synchronization requests during periods of Internet connection outages.

As shown in FIG. 4, the Transaction Synchronization Process wakes up periodically and checks to see if there are any transactions are in the synchronization queue and if the Internet connection is functional. If so, it synchronizes each queued transaction by passing the original Thin Client's request to the server, comparing the server's answer with the stored answer already given by the ICR Transaction Listener Process. If no answer is received, the synchronization request is left in the queue. If the answer received differs from the stored answer differ. the ICR sends an “exception” transaction to the remote processor, informing it of the anomaly. The synchronization event is removed from the queue, and any additional queued transactions are processed.

### Data Cache Control Process Logic

The ICR Data Cache Control Process is responsible for making sure that all items in the data cache—that is, all data that is necessary for mission-critical functionality—is up to date and mirrors the primary copy of such data on the remote server.

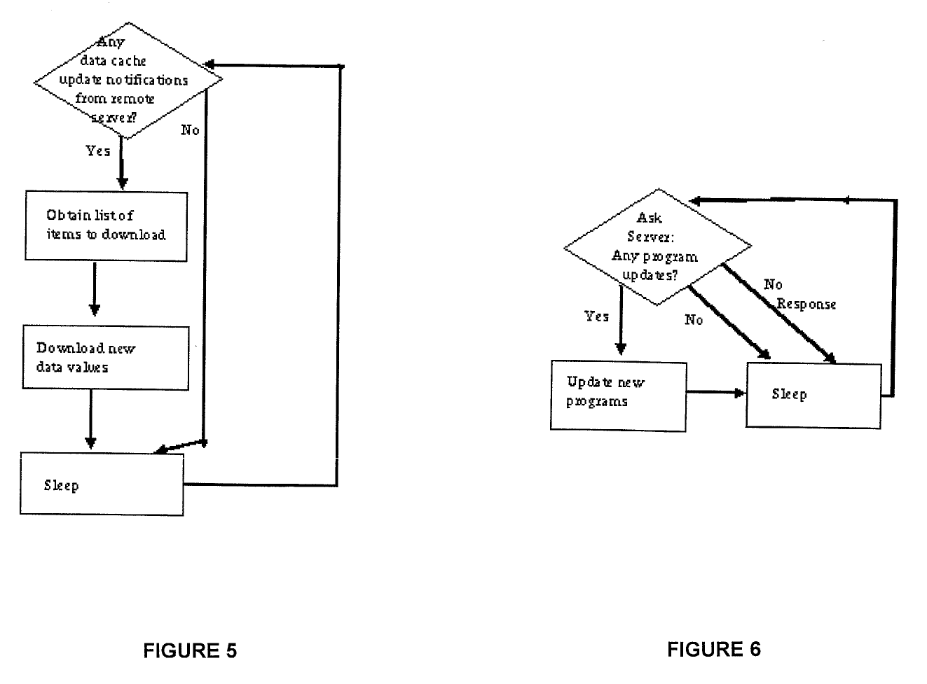

As shown in FIG. 5, the Data Cache Control Process simply waits for the remote server to notify it of data that needs to be updated, and then downloads that data from the remote server. Internet outages that occur during this update process simply cause the updating to be delayed until connectivity is restored.

### Program Cache Control Process Logic

The ICR Program Cache Control Process is responsible for making sure that all items in the program cache—that is, all of the actual executable or interpreted programs that are necessary for mission-critical functionality—are up to date and mirror the primary copy of such programs on the remote server.

As shown in FIG. 6, the Program Cache Control Process periodically polls the remote server to request a list of programs that needs to be updated, and then downloads those programs from the remote server. Internet outages that occur during this update process simply cause the updating to be delayed until connectivity is restored.

### Alternative Implementations and Embodiments

The logic flows just described are only one general outline of ICR logic processing. Many variations are possible. For example:

An ICR might be instantiated on a general purpose computing box, in which case various additional operating system processes might be occurring simultaneous with the logic outlined here.

Firewall and other routing functionality may be combined with the ICR logic. Thus, for example, where Transaction Listener Process step 2.a. 1 says “reroute transaction to remote server” this might actually mean redirection through the firewall component of the ICR.

The program cache and data cache control processes could be merged into a single process. They are shown here as separate processes because they have different requirements for latency and data reliability and thus might be processed on different schedules. In this example, the data cache is implemented with server notifications for changed data elements, while the program cache is implemented with periodic client-side polling. Either policy, or various other policies, might be implemented for the control of either of the two caches.

We claim:

1. In an application service provider (ASP) computing environment wherein a client interacts with a remote server over a shared network, a method of increasing transaction reliability, comprising the steps of:
maintaining a list of critical transactions;
locally caching at least certain processing capabilities associated with the application;
monitoring requests from the client to determine if a request relates to one of the critical transactions; and, if so:
processing that transaction locally and returning a response directly to the client.

2. The method of claim 1, further including the step of synchronizing the transaction with the remote server after processing the request.

3. The method of claim 2, wherein the synchronization contains both the request and the locally issued response.

4. The method of claim 1, assuming the request does not relate to a critical transaction, further including the step of transparently routing the transaction to the remote server if the network is functioning and, if not, returning a failure message to the client if the network is unavailable or if the server is otherwise inaccessible.

5. The method of claim 1, further including the step of monitoring the connectivity of the network in a background mode and, if a problem with connectivity is detected, taking one or more actions to overcome the problem.

6. The method of claim 5, wherein one of the actions used to overcome a problem associated with network connectivity includes routing traffic to an alternative network provider.

7. The method of claim 5, wherein one of the actions used to overcome a problem associated with network connectivity includes establishing communication through a backup link.

8. The method of claim 5, wherein one of the actions used to overcome a problem associated with network connectivity includes the use of an alternative communications infrastructure to notify network administrators of the problem.

9. The method of claim 1, wherein the application is associated with electronic commerce.

10. The method of claim 9, wherein the client is associated with a store having one or more point-of-sale terminals.

11. The method of claim 10, wherein sales, transactions are identified as critical, whereas functionality related to reporting, inventory data, and customer relationship or management are considered non-critical.

12. The method of claim 9, wherein the network is the internet.

13. In a network computing environment wherein a client interacts with a remote server providing access to an application, an intelligent caching router comprising:
a component containing software, hardware, or both, situated proximate to the location of the client and functioning as an interface to the network, the component storing a list of critical transactions and at least some of the processing capabilities associated with the application,
the component being operative to perform the following functions:
a) monitor requests from the client to determine if a request relates to one of the critical transactions; and, if so:
b) process that transaction locally and returning a response directly to the client.

14. The intelligent caching router of claim 13, wherein the component is further operative to synchronize the transaction with the remote server after processing the request.

15. The intelligent caching router of claim 14, wherein the synchronization contains both the request and the locally issued response.

16. The intelligent caching router of claim 13, assuming the request does not relate to a critical transaction, the component being further operative to transparently route the transaction to the remote server if the network is; functioning and, if not, return a failure message to the client if the network is unavailable or if the server is otherwise inaccessible.

17. The intelligent caching router of claim 13, the component being further operative to monitor the connectivity of the network in a background mode and, if a problem with connectivity is detected, take one or more actions to overcome the problem.

18. The intelligent caching router of claim 17, wherein one of the actions used to overcome a problem associated with network connectivity includes routing traffic to an alternative network provider.

19. The intelligent caching router of claim 17, wherein one of the actions used to overcome a problem associated with network connectivity includes establishing communication through a backup link.

20. The intelligent caching router of claim 17, wherein one of the actions used to overcome a problem associated with network connectivity includes the use of an alternative communications infrastructure to notify network administrators of the problem.

21. The intelligent caching router of claim 17, wherein the application is associated with electronic commerce.

22. The intelligent caching router of claim 13, wherein the client is associated with a store having one or more point-of-sale terminals.

23. The intelligent caching router of claim 22, wherein sales transactions are identified as critical, whereas functionality related to reporting, inventory data, and customer relationship or management are considered non-critical.

24. The intelligent caching router of claim 13, wherein the network is the Internet.

25. The intelligent caching router of claim 13, further including routing or firewall functionality associated with the application.

26. The intelligent caching router of claim 13, wherein the component is further operative to perform DNS (domain name system) lookup, DHCP (dynamic host configuration protocol) service, and any other network services that are essential for the functioning of the local client.

27. In an application service provider (ASP) computing environment wherein a client interacts with a remote server over a shared network, the improvement comprising:
an intelligent caching router (ICR) inserted functionally between the client and the network, such that when conventional backup routing, fails, the ICR begins to act as a surrogate for the unreachable remote server on which the application service depends.
